(19) United States
(12) Patent Application Publication
(10) Pub. No.: US 2005/0256773 A1
(43) Pub. Date: Nov. 17, 2005

(54) Paper products in roll form having printed elements thereon

(76) Inventor: Bradley A. Cole, Winter Springs, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 11/148,816

(22) Filed: Jun. 8, 2005

Related U.S. Application Data
(63) Continuation-in-part of application No. 10/445,371, filed on May 23, 2003.
(60) Provisional application No. 60/383,032, filed on May 24, 2002.

(51) Int. Cl. A47B 7/00; G06F 17/60

(52) U.S. Cl. 705/14; 5/622

(57) ABSTRACT

A plurality of elements are disposed on a continuous sheet of coiled paper product. The elements are repeated with a repetition rate determined by the use for the paper product. In the application to an examining room table, the repetition rate is determined by the length of the table.

This patent application is a continuation-in-part of the non-provisional patent application assigned application Ser. No. 10/445,371 filed on May 23, 2003, which claims the benefit of the provisional patent application assigned Application No. 60/383,032 filed on May 24, 2002.

### BACKGROUND OF THE INVENTION

The typical physician's examining room includes an examining table on which the patient lies or sits during the medical examination. The examining table is constructed with a metal frame and a cushioned upper surface that can be adjusted to support the patient in various positions during the examination. For sanitary purposes, it is known to provide a paper cover for the cushioned surface, where the paper is replaced after each patient visit.

The paper is provided from a substantially cylindrical paper roll stored in a cradle at the head or foot end of the examining table. To replace the paper between patient visits, the nurse or attendant separates the soiled length of paper from the roll and replaces it with a new length of paper withdrawn from the roll and extended over the cushioned upper surface. The paper is dispensed by grasping the leading edge of the paper and withdrawing paper as the roll rotates within the cradle. In lieu of disposing the paper roll in a cradle, the roll is rotatably mounted on an axle that extends through the roll and is appropriately mounted below the table surface at either the head or foot end.

Similar paper covers are also employed with head message tables, baby scales and chiropractic tables. In each case, the paper provides a clean and sanitary surface for the next user.

### BRIEF SUMMARY OF THE INVENTION

According to one embodiment, the present invention comprises a method for providing advertising to patients in an examination room having an examination table, the method comprising: disposing first advertising media on a pad of the examination table and replacing the first advertising media with a second advertising media after the patient has exited the examination room, wherein the second advertising media comprises different advertising content than the first advertising media.

### BRIEF DESCRIPTION OF THE DRAWINGS

The foregoing and other features of the invention will be apparent from the following more particular description of the invention, as illustrated in the accompanying drawings, in which like reference characters refer to the same parts throughout the different figures. The drawings are not necessarily to scale, emphasis instead being placed upon illustrating the principles of the invention.

FIG. 1 illustrates a plurality of paper segments constructed according to the teachings of the present invention.

FIG. 2 illustrates a stack of interfolded paper products constructed according to the teachings of the present invention.

FIGS. 3-5 illustrate various embodiments of the present invention associated with paper products coiled about a roll or tube.

FIG. 6 illustrates an examining table to which the teachings of the present invention can be applied.

FIG. 7 illustrates a head massage table to which the teachings of the present invention can be applied.

FIG. 8 illustrates a chiropractic table to which the teachings of the present invention can be applied.

FIG. 9 illustrates a baby weighing table to which the teachings of the present invention can be applied.

### DETAILED DESCRIPTION OF THE INVENTION

Before describing in detail the particular paper product rolls in accordance with the present invention, it should be observed that the present invention resides primarily in a novel and non-obvious combination of elements. Accordingly, the elements have been represented by conventional elements in the drawings, showing only those specific details that are pertinent to the present invention, so as not to obscure the disclosure with structural details that will be readily apparent to those skilled in the art having the benefit of the description herein.

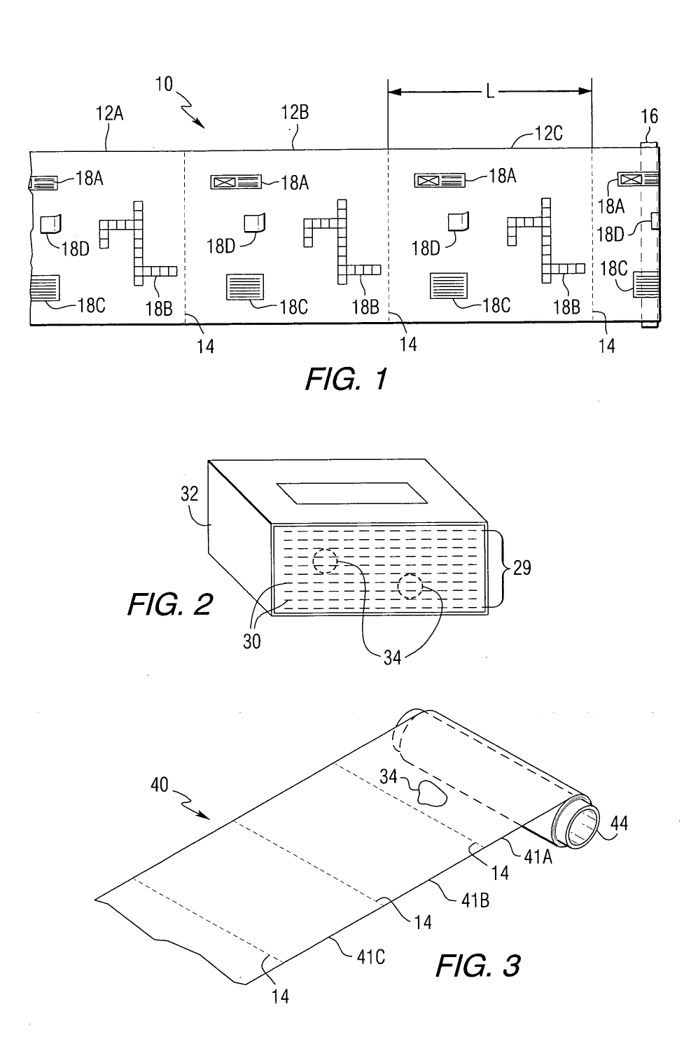

As illustrated in FIG. 1, according to one embodiment of the teachings of the present invention, the examining table paper 10 (also referred to as sanitary paper) is sectionalized into length regions 12A, 12B and 12C, each region having a length “L” approximately equivalent to the paper length required to cover an examining table. Section defining lines 14 represent perforations for ease in separating a soiled section of paper from a roll 16. In another embodiment the paper 10 is not perforated and thus the lines 14 represent imaginary lines of demarcation between regions 12A, 12B, 12C, etc. solely for the purpose of explaining the present invention.

In exemplary embodiments the length “L” is about three feet or about six feet, and the total paper length is about 225 feet. The paper width is dependent on the apparatus with which it is employed, including widths of 8 inches, 18 inches and 21 inches. Conventionally, as is known in the art, the examining table paper 10 comprises crepe machine grade paper.

Various items or elements (or groups of elements or items) are printed or embossed on or detachably or liftably mounted (using a liftable adhesive for easy removal) to the paper 10 with a repetition rate (or distance between items or elements) determined by the sectionalized length such that the items or elements (or groups of elements or items) appear in each region 12A, 12B and 12C. Thus one (or more) instance of each item or element (or groups of elements or items) is present in the paper length covering the examining room table. Each time a soiled section of the paper 10 is removed and replaced by a clean paper section the item or element appears in the clean paper section.

Those skilled in the art recognize that multiple embodiments of this concept are also implementable. For example, groups of items or elements are printed on or detachably mounted to the paper 10. Additionally, the repetition rate of the items or elements or groups thereof can be increased such that the items, elements, or groups thereof appear more than once in each region 12A, 12B and 12C. The repetition rate can also be decreased such that the items, elements, or groups thereof appear on some but not all of the paper sections 12A, 12B and 12C. Further, the repetition rate can be predetermined (e.g., every third or fifth section) or random. In yet another embodiment a first predetermined group of items or elements are alternated with a second group of items or elements.

FIG. 1 illustrates several different types of elements 18 that can be printed on or detachably mounted to the paper 10. Elements 18A are redeemable coupons for an over-the-counter or prescription medication commonly recommended by the physician. Elements 18B represent a game, such as a crossword puzzle. Elements 18C are detachable or perforated areas on which the physician makes notes for the patient for later review.

Generally, the elements 18 are intended to relate to the medical services provided, and further to enhance or add value to the patient's encounter with the physician. Exemplary element types include: inspirational, motivational, artistic, informative and educational. Inspirational elements include emotive artistic works with an inspirational message. Exemplary informative and educational elements, typically detachable or removable by the patient for review outside the physician's office, provide details of a medical condition or the medications available to treat a medical condition. The element 18 also includes a follow-up regimen for the patient to execute. A table in which the patient is to insert self-administered blood pressure measurements is one example of such a follow-up regimen. In yet another embodiment, the element 18 comprises a pharmaceutical questionnaire.

Games or other entertaining elements to occupy the patient's waiting time in the examining room can be printed on the paper 10. Game artwork thus appears in each section 12A, 12B and 12C. Exemplary word games include crossword puzzles, acrostics and anagrams. For a pediatrician's office one of the elements includes a child's tattoo that can be easily applied to and removed from the child's skin.

Value, reward, promotional or incentive elements include vendor discount or free-sample coupons or entries to contests sponsored by pharmaceutical companies or medical product vendors. Non-medical product or service coupons can also be placed on the paper 10. The value elements, like all of the elements 18, in one embodiment are perforated for easy separation from the paper 10, or printed on a separate paper and attached to the paper with a liftable adhesive. Exemplary liftable elements are referred to by reference character 18D in FIG. 1.

In another embodiment, an element 18 comprises a game token for redemption if certain game conditions are satisfied. The redeeming party comprises a supplier of medical products or the physician's office.

Element 18C includes a detachable physician's note area on which the physician makes notations for the patient to take from the examining room. For example, the patient may be instructed to perform certain daily exercises to alleviate an identified physical condition. Rather than expecting the patient to remember these instructions, the physician writes the instructions on the detachable area of the paper while explaining the instructions to the patient. In another embodiment the element 18C includes pre-printed material and blanks for the physician to insert the patient's name, date, condition, patient-specific instructions, etc.

The teachings of the present invention can also be applied to any paper or paper-like products or sheets that are serially dispensed from a container, housing or roll. For example, a stack 29 of interfolded products 30 (see FIG. 2) dispensed individually from a housing 32, include randomly placed game winning coupons, merchandise discount coupons or other element types 34 nested within the stack 29. When the user withdraws a product 30 from the housing, the element is also withdrawn.

According to another embodiment of the present invention, as illustrated in FIG. 3, a paper roll 40 (e.g., toilet tissue, gift wrap paper or paper towels) comprises sheets 41A, 41B and 41C coiled about a roll 44, and further including randomly spaced game elements 34 or merchandise coupons among the sheets 41. The sheets 41 are separated by sheet defining lines 14.

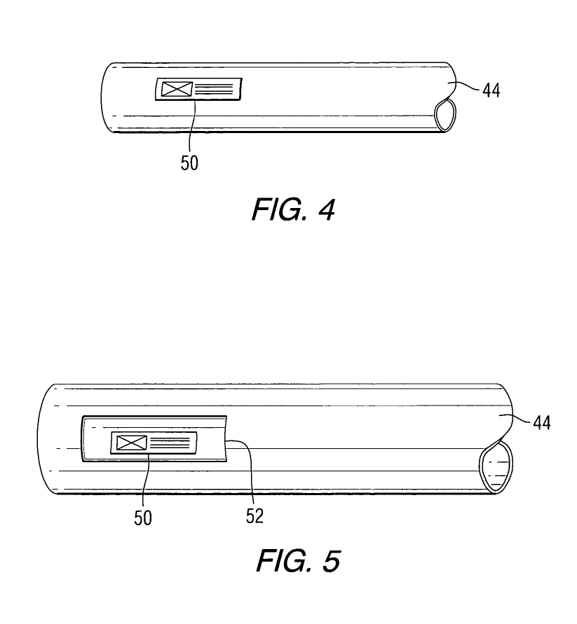

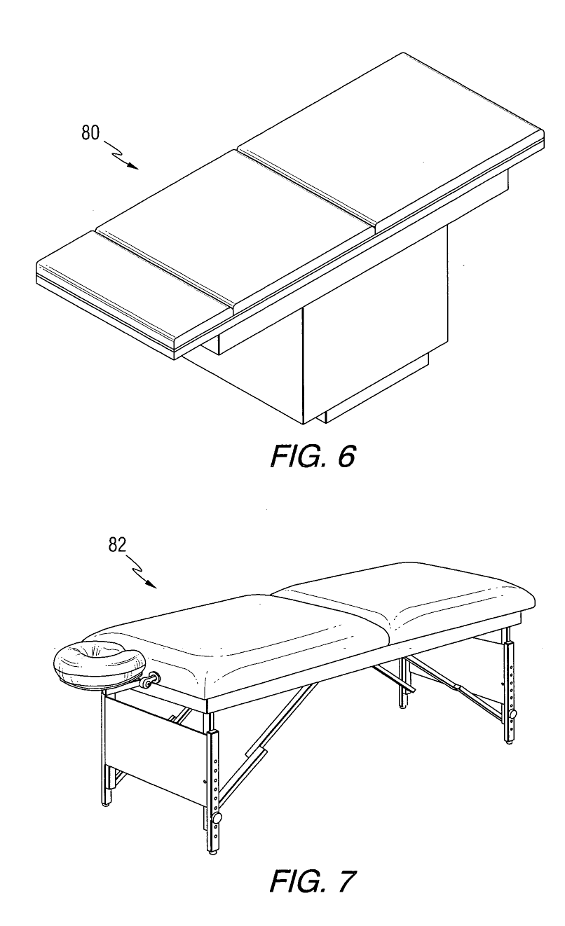

In another embodiment illustrated in FIG. 4, the roll 44 includes an element 50, for example, a game piece or merchandise discount coupon, that is not accessible until the entire product has been dispensed and the end of roll has been reached. Various prizes can be awarded by the product supplier, with valuable prizes awarded less frequently than less expensive prizes. In one embodiment the tube 44 represents a tube for coiling the examining table paper described above. The game piece or merchandise discount coupon is redeemed by a member of the physician's staff who is responsible for inserting a new paper roll into the dispensing mechanism of the examining table. Alternatively, all members of the staff can receive benefits from the coupon redemption.

In lieu of affixing the game piece or coupon 50 to the roll 44, an opening 52 is formed in the roll 44 and the element 50 is then visible or accessible through the opening 52. The element 50 is not exposed until after all the product has been dispensed from the roll 44.

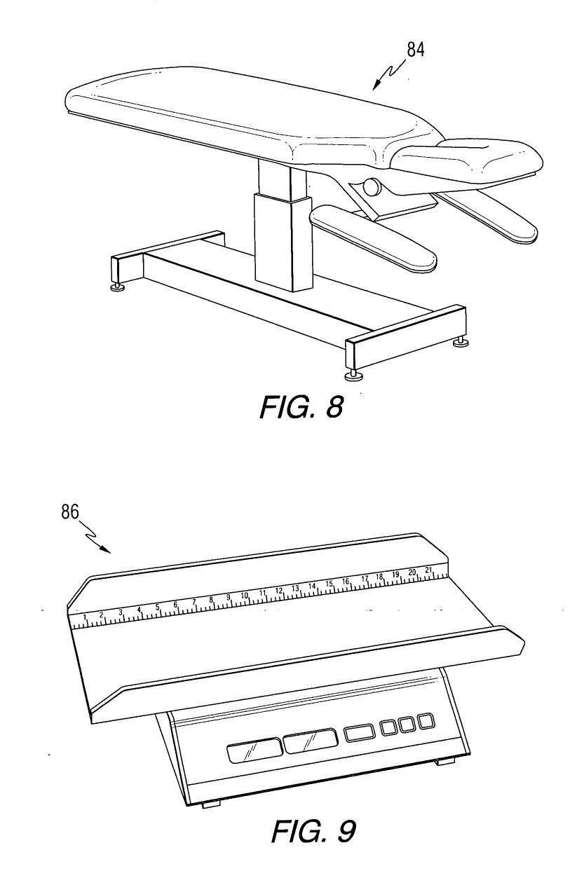

FIG. 6 illustrates an examining table 80 to which the teachings of the present invention can be applied. FIG. 7 illustrates a head massage table 82 to which the teachings of the present invention can be applied. FIG. 8 illustrates a chiropractic table 84 to which the teachings of the present invention can be applied. FIG. 9 illustrates a baby weighing table 86 to which the teachings of the present invention can be applied.

According to another embodiment of the invention, educational/informational elements (e.g., in the form of textual and/or graphical elements) disposed on the examining table paper describe a specific disease or a treatment regimen associated with a medical condition. Preferably, the educational/informational elements relate to medical conditions treated by the physician in whose office the examining table paper is utilized.

In another embodiment, advertising elements (e.g., product logos, prescription drug brand names) are disposed on the examining table paper. A first media comprising advertising content is disposed on the examining table paper. The paper is replaced with paper bearing second advertising media after the patient has exited the examination room, wherein the second advertising media comprises different advertising content than the first media.

A patient information solicitation card (e.g., a survey card), preferably related to the educational/informational element on the examining table paper, is present in the examining room or removably attached to the examining table paper. The card solicits the patient for information regarding aspects of the educational/informational element presented on the table paper. For example, the card solicits the patient to opine as to the usefulness or comprehensibility of the educational/informational element.

In addition to its informational/educational function, the examining table paper can provide marketing opportunities for medical product and service suppliers to a captive audience, i.e., a patient in the examining room waiting for the physician or other health care professional to enter for the consultation or examination. For example, a medical service or product supplier provides the examining table paper (i.e., a paper sponsor) for use by the physician on her examining room tables. The paper carries informational/educational elements related to the service or product supplied by the sponsor and the solicitation card prompts the patient to supply information related to service or product supplied or any other aspects of the health care delivery system. The card may also request patient information to permit the sponsor to better target users of its products or services. In another embodiment, the survey card further comprises a discount coupon for use by the patient in his or her next purchase of the advertised product or service. In sum, the examining table paper attracts the patient's attention while waiting in the examining room, provides educational/informational data to the patient through the informational/educational elements and the card provides a feedback mechanism for supplying commentary on the informational/educational information or other health care matters.

While specific applications and examples of the invention have been illustrated and discussed, the principals disclosed herein provide a basis for practicing the invention in a variety of ways and in a variety of applications. Numerous variations are possible within the scope of the invention. The invention is limited only by the claims that follow.

1. A method for providing advertising to patients in an examination room having an examination table, the method comprising:
disposing first advertising media on a pad of the examination table; and
replacing the first advertising media with a second advertising media after the patient has exited the examination room, wherein the second advertising media comprises different advertising content than the first advertising media.

2. The method of claim 1 wherein the step of disposing further comprises uncoiling the first advertising media from a paper roll and extending the first advertising media across the pad.

3. The method of claim 2 wherein the step of replacing further comprises uncoiling the second advertising media from the paper roll and extending the second advertising material across the pad.

4. The method of claim 1 wherein the first media further comprises medical instructional material.

5. The method of claim 1 wherein the first or the second advertising media comprises a logo identifying a supplier of medical services or products.

6. A method for receiving information from a patient, comprising:
creating a plurality of artistic drawings and a plurality of messages concerning topics of interest to people generally;
disposing the drawings and messages in predetermined patterns on a paper cover of a physician's examining room table such that some of the drawings and messages are visible on the paper cover when the cover is placed on the examining room table in view of the patient; and
soliciting health-related information from the patient.

7. The method of claim 6 wherein the plurality of messages comprise a plurality of messages having an educational component.

8. The method of claim 6 wherein the plurality of messages comprise a plurality of messages having an informational content.

9. The method of claim 6 wherein the step of soliciting further comprises providing the patient with an information request card posing health-related questions to the patient.

10. The method of claim 9 wherein the information request card further comprises the information request card and a discount voucher.

11. The method of claim 6 wherein the step of soliciting further comprises soliciting information related to one or more of the plurality of messages.

12. The method of claim 6 wherein the step of soliciting further comprises providing the patient with an information request card posing questions to the patient, wherein the information request card is made available to the patient in an examining room in which the examination table is disposed.

13. The method of claim 12 wherein the information request card further comprises a discount voucher for use by the patient.

14. The method of claim 6 further comprising disposing a removable information request card on the paper, wherein the step of soliciting further comprises using the card to solicit information associated with the messages from the patient.

15. The method of claim 6 wherein one or more of the plurality of messages provide information regarding a medical condition or a treatment of a medical condition.

16. The method of claim 6 wherein the messages comprise advertising media related to a product offered by a sponsor, the method further comprising analyzing the health-related information solicited from the patient, wherein the analysis is conducted by the sponsor.
